(19) United States
(12) Patent Application Publication
(10) Pub. No.: US 2015/0026930 A1
(43) Pub. Date: Jan. 29, 2015

(54) CLOSURE DEVICE FOR A CABLE SLING, SECURING DEVICE, HIGH-PRESSURE DEVICE, AND METHOD FOR ASSEMBLING THE SECURING DEVICE

(71) Applicant: Hartmut Schmitz, Siegen (DE)

(72) Inventor: Hartmut Schmitz, Siegen (DE)

(21) Appl. No.: 14/390,313

(22) PCT Filed: Oct. 30, 2012
(86) PCT No.: PCT/EP2012/004534

§ 371 Date: Oct. 2, 2014

(30) Foreign Application Priority Data
Apr. 3, 2012 (DE) 10 2012 006 648.1

(51) Int. Cl. F16L 55/00; F16G 11/06; F16G 11/14

(52) U.S. Cl. CPC F16L 55/005; F16G 11/146; F16G 11/06
USPC 24/115 K; 248/499; 285/61; 29/428

(57) ABSTRACT

A closure device for a cable sling which is placed around a line for securing purposes. The closure device has a clamping sleeve together with a locking sleeve, both cable portions of the sling being lockable in the locking sleeve in a non-displaceable manner. In order to lock the cable sling on the line in a non-displaceable manner, the closure device is designed such that the cable sling can be tightened, wherein the distance between the clamping sleeve and the locking sleeve can be increased by a screwing process for example.

The invention pertains to a closure device for a cable sling formed out of a first and a second cable section. The closure device consists, among other things, of a locking sleeve with at least one bore for the passage of the first and second cable sections.

In addition to the closure device and to the method, the invention also pertains to a securing device and to a high-pressure device.

Japanese references JP 57 141252 U, JP 57 155345 U and JP 62 191115 U disclose in general a closure device for a sling of a cable, whereby the cable sling is formed from a first and a second cable section, which are guided through a locking sleeve and a clamping sleeve. In all three listed references, the locking of the two cable sections results from clamping of the clamping sleeve and the locking sleeve against one another. In this way the clamping sleeve cannot be used for clamping the sling without the sling being locked.

A further closure device is known from German publication DE 11 71 802 B, in which the closure device is constructed in the form of a clamping body. The clamping body has a central bore for guiding the two cable sections of the sling and it has on its outer surface incisions for introducing and fixedly clamping the cable sections. In this way the sling is secured against loosening.

Finally, from US document U.S. Pat. No. 1,495,258 A, a closure device for a cable sling is also known, in which at least one of the two cable sections is fixed in a bore of a locking sleeve with the assistance of conical clamping elements. A reclamping of the cable sling with the aid of a clamping sleeve is also not shown here.

In the case of high-pressure devices such as hydraulic installations, which typically comprise a high-pressure fitting to which a (high-pressure) line is connected, there is the danger that the line can come loose from the high-pressure fitting and then thrash around uncontrollably. This undesirable event is also called the “whiplash effect”.

Numerous approaches to a solution to this problem are already known from the prior art. In the typical case, a capture cable is provided, one end of which, or a sling, is placed around the (high-pressure) line, while the other end is fastened to the stationary high-pressure fitting. Examples of these types of capture cables for high-pressure lines can be found, for example, on the Internet at the home pages of various vendors, including www.hsr.de and www.dietzelhydraulik.de. In the variants to be found there, the capture cable is typically fastened to the (high-pressure) line by means of a hose clamp. Providing hose clamps requires that an appropriate inventory be maintained and that the clamps be mounted on the (high-pressure) lines in tight spaces, which is often finicky and time-consuming.

Alternatively, a capture cable in the form of a sling can be placed around the (high-pressure) line as disclosed in the utility model documents DE 296 98 853 U1 and DE 20 2004 003 544 U1.

When the cable slings are laid “by hand” directly around the lines, as provided according to the utility models, they are not usually fastened to the line in sufficiently immovable fashion. The reason for this is that cable slings, typically wire cable slings, are stiff and therefore assume a teardrop-like shape, which prevents them from resting fully around the entire circumference of the line. So that the cable lies firmly around the entire circumference of the line, a large amount of force must be exerted, which typically can be applied only by means of a special tool.

Proceeding from this prior art, the invention is based on the goal of elaborating a closure device, a securing device, high-pressure device, and a method for mounting the securing device on a line in such a way that that the mounting process can be simplified and the mounting time can be shortened.

This goal is achieved with respect to the closure device by the object of claim 1. Accordingly, the closure device is characterized in that the locking sleeve and the clamping sleeve—holding the cable sections which have been fed through both sleeves—are fixable in variably adjustable relative positions to each other for reclamping the cable sling around the line by partially unscrewing a screw connection between the locking sleeve and the clamping sleeve to a greater distance; and cable securing means are provided for locking the first and second cable sections in the locking sleeve in such a way that the cable sling will not loosen.

The term “line” is to be understood primarily as a flexible line, e.g., a hose, for a medium, but as a secondary meaning it can also refer to tubing. In particular, high-pressure hoses, e.g., hydraulic hoses in particular, fall under the concept of “line”, wherein “high pressure” means any pressure greater than atmospheric pressure.

The term “cable section” designates the partial length of cable which forms half of the sling, i.e., the part up to the turning point. A cable sling is accordingly formed by two cable sections, which meet each other at the turning point of the sling.

The advantage of the claimed closure device consists in its double function: The locking sleeve makes it possible to pretension the cable sling laid around the line, after which the cable sections of the sling are permanently fixed in the locking sleeve. In the following step, the clamping sleeve makes it possible to reclamp the sling, i.e., to pull it even tighter, to the desired degree. This reclamping is made possible by the ability to variably adjust and fix the relative positions of the locking sleeve and the clamping sleeve to each other, that is, in particular by the possibility of increasing the distance between the two sleeves. It is very easy to handle and to mount the closure device, and the process can be readily achieved in a short time, as will be explained further below in conjunction with the description of the method according to the invention. No special tool is required to handle or to mount the sling or even to carry out the reclamping step. Finally, the closure device according to the invention has a compact structure, so that it can be easily and reliably handled even in tight spaces.

The locking sleeve is formed with an outside thread and the clamping sleeve is formed with a complementary inside thread, or vice versa, so that the two sleeves can be screwed together. This screw joint makes it much easier to reclamp the cable sling, because the screw joint makes it easy to change and to secure the axial distance between the locking sleeve and the clamping sleeve.

By means of the securing means in the locking sleeve, it is ensured that the cable sections cannot move in such a way that the sling can become loose.

According to a first exemplary embodiment, the locking sleeve and/or the clamping sleeve comprises either individual bores or a common bore to accommodate the first and second cable sections and possibly, as an option, a third cable section, i.e., the other, free end of the cable.

The locking sleeve and/or the clamping sleeve advantageously comprises, on its outer surface and extending in the longitudinal direction of the bore, a slot or several slots, which communicate with the at least one bore to facilitate the insertion of at least one of the cable sections into the bore of the sleeve. The slot simplifies the handling of the closure device to the extent that it is not necessary to introduce, into the bore, the end of the cable section to be fed through the sleeve; instead, it is possible to place a lengthwise section of the cable into the slot. Cables with untwisted ends often cannot be fed through the bores provided for them; this problem is eliminated now, because the cable sections can be laid into the slot.

When the locking sleeve is configured without a slot, the ends of the cable are fed into the locking sleeve through two separate bores or through a common bore. This variant is the simplest in terms of manufacturing and also the least expensive. For first-time hose installations, which must be accomplished at the lowest possible cost, this variant would be completely adequate, because the cable sling can be pushed over the end of the hose. The hose is installed only after that. The overall structure remains stronger than it would be if a slot were present.

The disadvantage: in the installed state, the sling cannot be removed again without disconnecting the high-pressure hose at some point. Oil, etc, can run out.

In the case of the configuration of the locking sleeve with two bores, one for the first cable section and another for the second cable section, wherein only one of the two bores is open or accessible to the outside through a slot, the following situation exists: The cable sling can be installed subsequently, i.e., around an already connected high-pressure hose, or removed from the hose later. This variant is simpler in terms of manufacturing and can be produced at lower cost than the configuration described below with two slots. The overall structure is sturdier than the configuration with two slots. The closure device according to the invention is, in a planned manner, connected strongly to the steel cable by means of the remaining through-bore. The mounting process is simpler than it is with the two-slot configuration.

Disadvantage a: The steel cable and the closure device cannot be treated as two separate components at the construction site. As a result, the cost of maintaining an inventory can increase
Disadvantage b: The overall structure is not as strong as one without a slot.

In the case of the configuration of the locking sleeve with two bores, one for the first cable section and another for the second section, wherein each bore is open to the outside of the sleeve through its own slot, the following situation exists: This variant is the “most flexible” of those cited, because, in the uninstalled state there is no permanent connection of any kind between the steel cable and the closure device. As a result, inventory costs are the lowest.

Disadvantage a: It is possible that the closure device could be dropped during assembly at the construction site. Depending on circumstances, this could have very negative consequences; Practical tests have also shown that this variant is the most cumbersome to install.
Disadvantage b: This is the most expensive variant to manufacture.
Disadvantage c: It is the “least stable” variant.

At least one of the cable securing means is preferably configured in the form of a headless screw, which can be screwed radially, i.e., transversely to the longitudinal axis of the bore, into the at least one bore of the locking sleeve to clamp or lock the cable sections in the at least one bore. The cable securing means is for its own part preferably secured against loosening by means of suitable securing means, e.g., a second setscrew.

The at least one bore in the locking sleeve advantageously comprises, at the end facing away from the sling, a widened area to receive an end-stop sleeve of the first or second cable section of the cable sling. When the end-stop sleeve is pulled into the widened area in the bore, the end-stop sleeve prevents the cable from shifting in the locking sleeve in such a way that the sling increases in size. Instead, the end-stop sleeve cooperates with the widened area the end-stop sleeve prevents the cable from shifting in the locking sleeve in such a way that the sling increases in size. Instead, the end-stop sleeve cooperates with the widened area to ensure that the cable sling cannot relax or loosen in the reclamped state as well.

According to another exemplary embodiment, the at least one bore in the clamping sleeve, at the end facing the sling, and/or the at least one bore in the locking sleeve, at the end facing away from the sling, comprises a countersink. The countersink at the end of the clamping sleeve facing the sling advantageously prevents a burr or sharp edge of the bore of the clamping sleeve from damaging the cable during reclamping. Analogously, the recess at the end of the locking sleeve facing away from the sling prevents a sharp edge or burr of the bore in the locking sleeve from damaging the cable when the cable, in the case of a problem, such as when the hose comes loose from the fitting, is subjected to transverse force, i.e., a force acting at least partially in a direction transverse to the longitudinal axis of the bore of the locking sleeve.

Optionally, the clamping sleeve comprises an inner sleeve, through which the cable sections are fed. Because its diameter is smaller than that of the clamping sleeve, the inner sleeve forms a narrowed channel for the cable sections, as a result of which the cable sling can be clamped more effectively in the case of a lines of small diameter as well.

During the clamping process, the clamping sleeve is screwed and thus rotated with respect to the locking sleeve; it is therefore possible, if no inner sleeve is provided, for the cable to be damaged by abrasion associated with the relative movement between the clamping sleeve and the cable.

The inner sleeve is supported freely rotatably in the clamping sleeve. This offers the advantage that the inner sleeve, in contrast to the clamping sleeve, does not co-rotate during the clamping process. Thus the relative movement between inner sleeve and cable and thus damage to the cable by abrasion are prevented.

The undesirable relative movement between inner sleeve and cable is also effectively prevented by optional notches on the sling-facing inside surface of the inner sleeve, when the cable sections fed through the inner sleeves engage in these notches on the sling side. The notches also blunt the edge by which the inner sleeve acts on the cable, because the notches form a larger radius, i.e., a recess, for the cable.

The inner sleeve can comprise a longitudinal slot. The longitudinal slot makes it possible for the cable sections to be introduced advantageously into the inner sleeve without the need to open the cable sling. This is advantageous in particular when securing devices and high-pressure devices with existing cable slings are to be retrofitted with an inner sleeve.

In principle, the screw joint alone is enough to ensure the securing of said relative distance of the sleeves to each other. To ensure that the relative positions of the sleeves to each other are permanently secured, especially under dynamic loads or under the action of forces which may develop, sleeve securing means in the form of headless screws, for example, can be provided.

To secure the cable securing means and the sleeve securing means for their own part against coming loose, additional securing means in the form of additional setscrews can be provided to clamp the securing means permanently down.

So that the cable sections are not damaged by contact with the end surfaces of the headless screws, it is advantageous to provide the end surfaces of the headless screws with half-shells, so that the cable sections are at least partially enclosed. As a result of the half-shells, the pressing force applied by the headless screws to the cable sections is distributed over a larger area and thus locally reduced.

As an alternative to the half-shells, it is also possible to provide a small metal plate between the end surfaces of the headless screws and the cable to be clamped, preferably a plate of brass. Brass is softer than steel. This produces the effect that the (wire) cable produces score marks on the side of the brass plate facing the cable under the pressure of the tightened-down headless screw. This has the advantageous result that damage to the (wire) cable which would be caused by, for example, the direct action of the end surface of the headless screw, is effectively prevented. The pressing-in of the (wire) cable into the brass plate when the headless screws are tightened also has the effect that the resistance to turning between the brass plate and the (steel) cable becomes much greater than that between the end surface of the headless screw and the side of the brass plate facing the headless screw. As a result of the pressing-in of the cable into the brass, therefore, the brass plate is also effectively prevented from rotating along with the headless screws when they are tightened. This offers the advantage that damage to the cable by abrasion resulting from relative movement between the brass plate the wire cable is effectively prevented.

As previously mentioned, no special tools are needed to handle or install the closure securing device. Nevertheless, a standard commercial leveraging tool such as an open-end wrench or similar tool is usually needed to reclamp the cable, i.e., to reclamp the cable sling, by means of the clamping sleeve. For this purpose, it is advantageous for the circumference of the locking sleeve and/or of the clamping sleeve to be formed with a hexagonal section, a section with two opposing flats with holes for hooks to engage, and/or a knurled section on which a suitable leveraging tool can be placed.

The previously mentioned goal is also achieved by a securing device for a line according to claim 13. The securing device comprises, according to the description given here, a cable, preferably a wire cable, and a closure device for a sling of the cable. By means of the securing device, the cable sling can advantageously be mounted compactly and immovably on the line. It is advantageous that the cable sling can also be mounted on “endless” lines, that is, it can be mounted without the need to slip the loop or sling formed at the end of the wire cable over one end of the line. This possibility is especially important, because installation on a medium-conducting line should be accomplished in such a way that this line does not have to be disconnected, which would be associated with the escape of the medium and the shutdown of the machine. Another advantage should also be mentioned, namely, that, even with a closure device of only one size, the securing device can be used for a relatively wide spectrum of line diameters. The provision of the inner sleeve in the clamping sleeve also serves this purpose in particular.

The cable can comprise the previously described end-stop sleeve on at least one of its ends. The bore in the locking sleeve then comprises, at the end facing away from the clamping sleeve, a widened area to accept the end-stop sleeve attached to a first end of the cable. In this widened receiving area, the end-stop sleeve engages with a stop; the end of the cable with the end-stop sleeve in the widened receiving area is thus prevented from shifting axially when the sling is pulled tight. In addition, a shift-preventing means in the form of a setscrew, for example, can be provided to secure the end-stop sleeve in the locking sleeve while the sling is still loose.

The securing device can also comprise connecting means for connecting the free second end of the cable, i.e., the end opposite the first end, to a stationary object. The second free end is guided out of the locking sleeve at the end facing away from the clamping sleeve and then, as an option, it can be fed back into the locking sleeve and fastened there; this is not necessary, however.

At least certain parts of the cable outside the closure device, especially in the area of the sling, are covered by plastic tubing, such as tubing made of polyurethane. The plastic tubing serves both to protect the cable and to protect the (high-pressure) line clamped by the cable.

The above-mentioned goal is also achieved by a high-pressure device according to claim 18. According to this claim, the high-pressure device comprises a line and high-pressure fitting, to which the line is connected. The high-pressure device is characterized by a securing device according to one of claims 13-17, wherein the sling of the cable is placed around the line and locked immovably on the line by means of the closure device according to one of claims 1-12. The free end of the cable is preferably connected by means of a connecting means to the high-pressure fitting some other stationary object.

The connecting means is configured in the form of, for example, an eyelet or a clamp, which is connected in a tension-withstanding manner to the high-pressure fitting or some other stationary object. A second closure device according to the invention or a modified closure device can also be provided to close a second cable sling formed from the free end of the cable. The second cable sling can be connected directly to the high-pressure fitting or indirectly to it via the connecting means. Now there are two slings on one and the same cable, one of which is connected to the high-pressure fitting, the other to the line, and each sling is secured with its own closure device according to the invention. The modified closure device comprises, for example, a symmetrically formed locking sleeve with threaded connectors at each end for two opposing clamping sleeves. The modified closure device functions the same way as a second, separate, simple closure device according to the invention would and is suitable for closing two slings of a cable securely according to the invention.

The above-mentioned goal is achieved, finally, by a method for mounting the securing device according to one of claims 13-17 to a line, preferably to a high-pressure hose. The method comprises the following steps: providing a cable, which has a first and a second cable section; passing the cable, the first and second sections of which are in the form of a sling, around the line; feeding the two cable sections through a locking sleeve and a clamping sleeve in such a way that the clamping sleeve is arranged between the cable sling and the locking sleeve; positioning the clamping sleeve preferably at the shortest possible distance from the locking sleeve; pulling the sling tight around the line; locking the two cable sections in the locking sleeve while the sling is pulled tightly around the line so that the sling cannot be loosened; and reclamping the cable sling around the line by partially unscrewing a screw connection between the locking sleeve and the clamping sleeve to a greater distance.

After the reclamping step, the clamping sleeve and the locking sleeve are fixed in their relative positions to each other, i.e., in the positions resulting from the increase in the distance between them, this fixation being achieved by means of headless screws, for example.

The advantages of the securing device, of the high-pressure device, and of the described method are the same as those cited above in conjunction with the closure device.

Additional advantageous embodiments are the object of the dependent claims.

Eleven figures in all are attached to the description, wherein

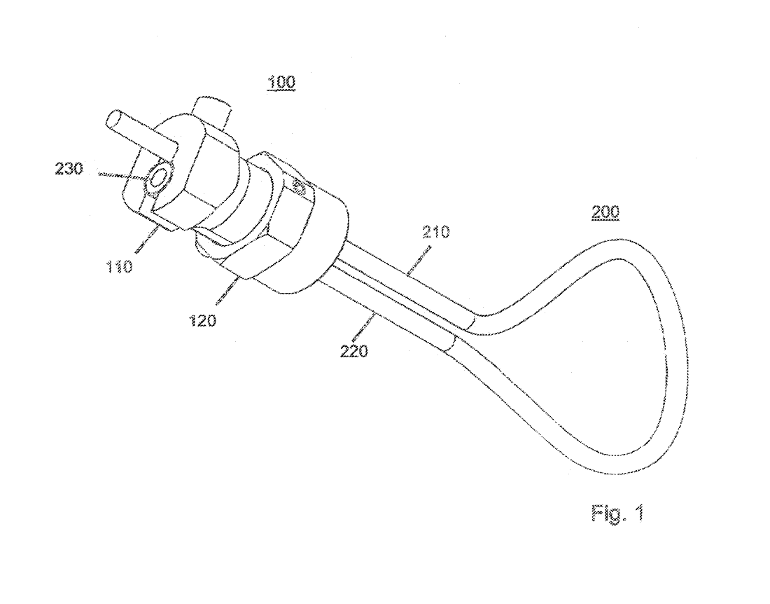

FIG. 1 shows a perspective view of the closure device and securing device according to the invention in the assembled state;

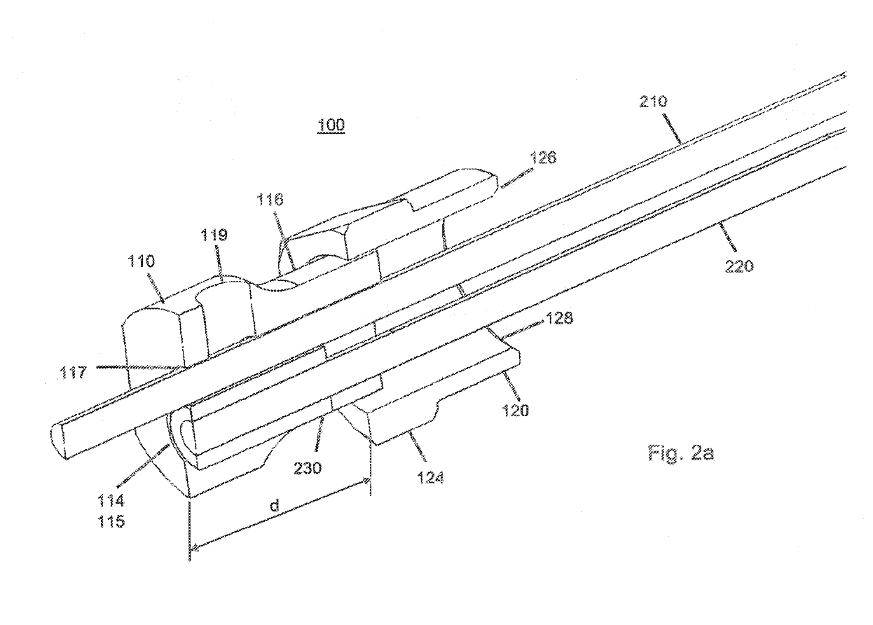

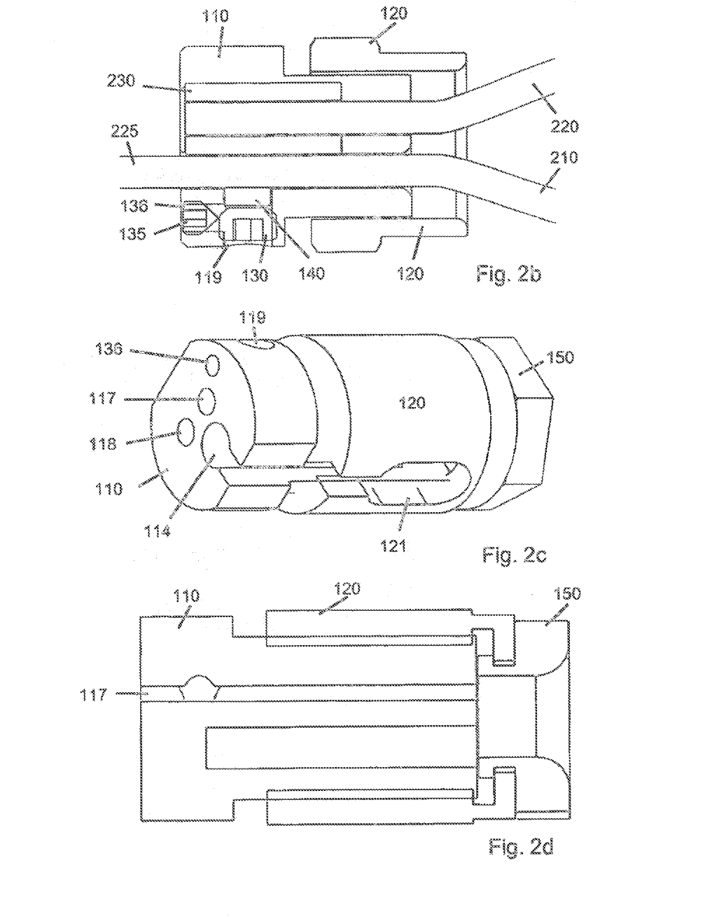

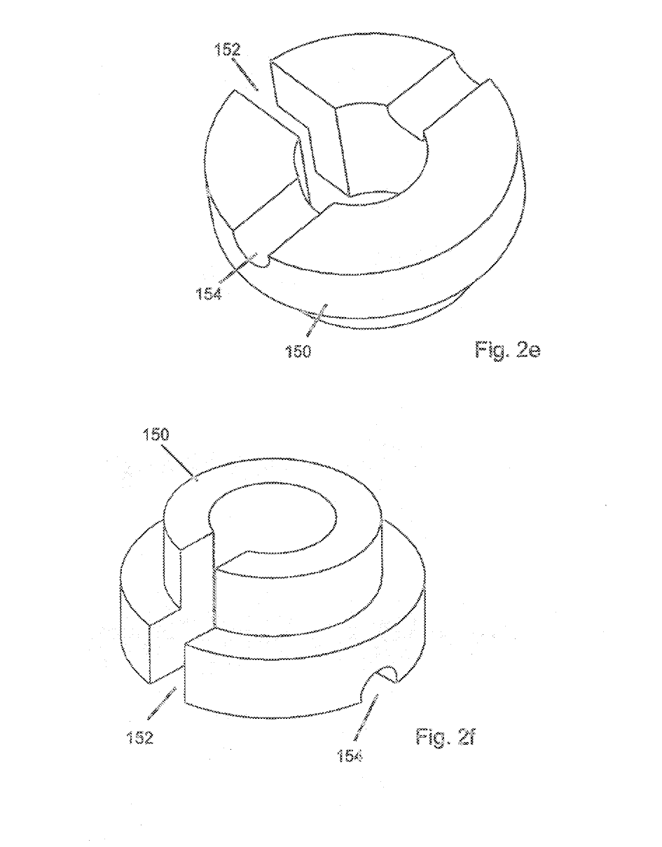

FIG. 2a shows a longitudinal cross section of the closure device and the securing device according to the invention;

FIG. 2b shows the closure device and the securing device according to the invention as shown in FIG. 2a with a small metal plate and additional securing means;

FIG. 2c shows a front view of the closure device and the securing device according to the invention with bores in the locking sleeve for an additional securing means and for the free end of the cable passing into the locking sleeve and back out of it again;

FIG. 2d shows a cross-sectional view of the closure device and securing device with inner sleeve according to the invention;

FIGS. 2e+f show front views of the inner sleeve;

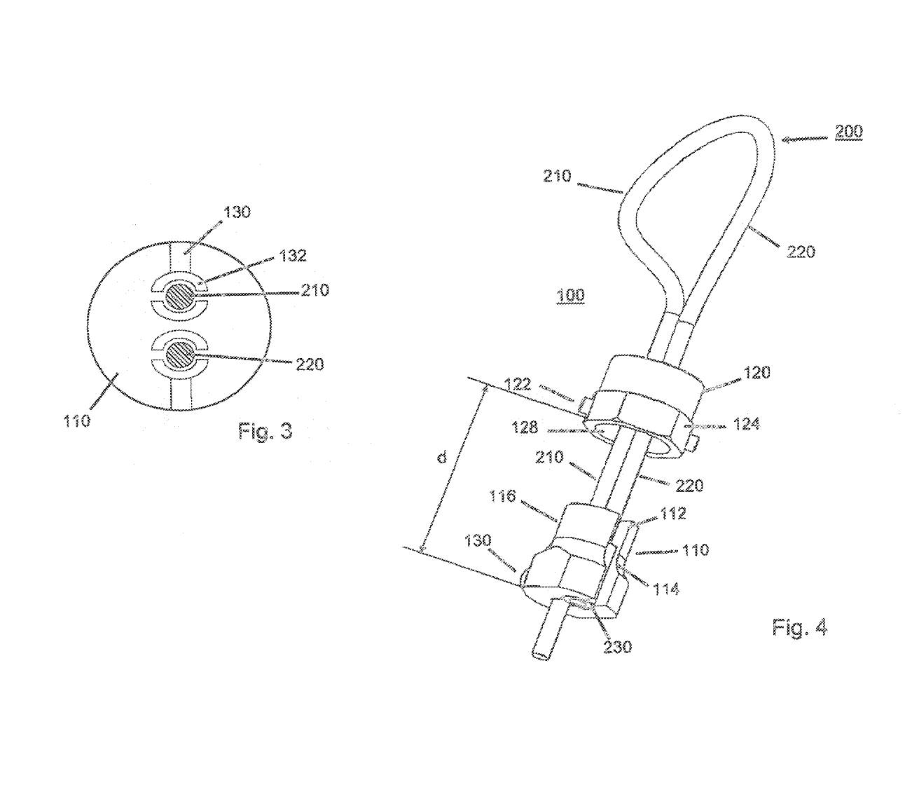

FIG. 3 shows the locking sleeve with headless screws and half-shells;

FIG. 4 shows the closure device and the securing device according to the invention in the unassembled state;

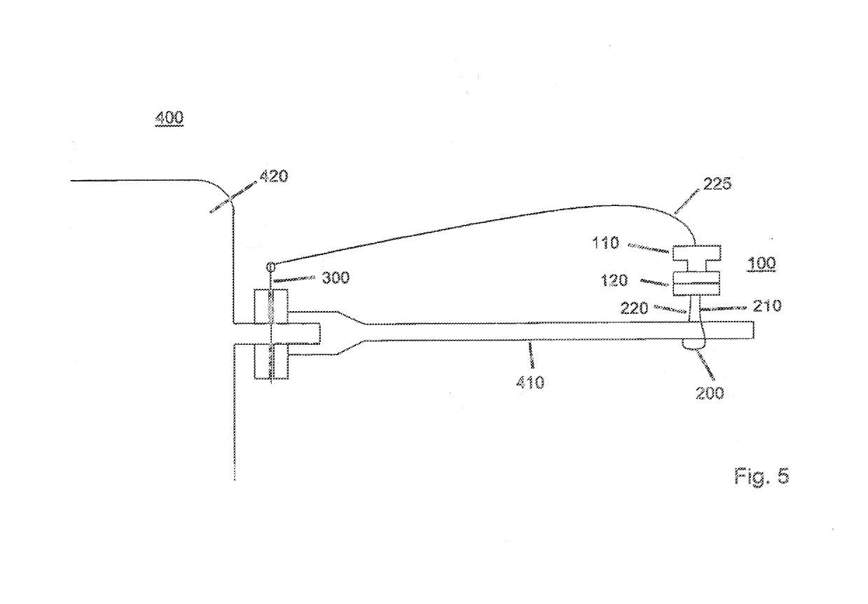

FIG. 5 shows the high-pressure device according to the invention; and

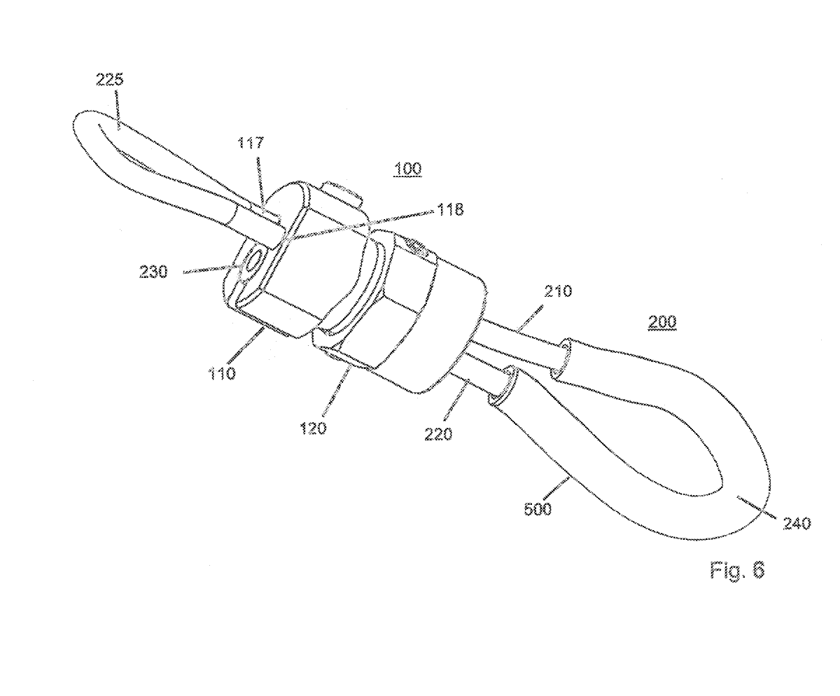

FIG. 6 shows a variant of the closure device and securing device of FIG. 1.

The invention is described in detail below in the form of exemplary embodiments with reference to the figures listed above. In all of figures, technical elements which are the same are designated by the same reference symbols.

FIG. 1 shows the securing device according to the invention. It comprises a cable, preferably a wire cable, with the two cable sections 210 and 220, formed into a cable sling 200. In addition to the cable, the securing device also comprises a closure device 100, which consists of a locking sleeve 110 and a clamping sleeve 120. Both cable sections pass through both sleeves 110, 120,

FIG. 2a shows a longitudinal cross section of the closure device 100 according to the invention.

In the case of the locking sleeve 110 shown in FIG. 2a, the two cable sections 210, 220 pass through separate bores 114, 117. The bore 114 for the cable section 220 comprises a widened area to accommodate an end-stop sleeve 230 mounted on the end of the second cable section 220. The end-stop sleeve 230, which is permanently connected to the second cable section 220, prevents the second cable section from shifting in one direction, such as toward the right in FIG. 2a, which could cause the sling 200 to become undesirably loose (see FIG. 1). So that the first cable section 210 can also be locked immovably in the bore 117 of the locking sleeve 110 to prevent the loosening of the sling, a radial or transverse bore 119 is provided in the locking sleeve to accommodate a headless screw. This transverse bore 119 extends all the way to the bore for the first cable section 210, so that this first cable section 210 can be held immovably in the locking sleeve by means of a headless screw 130 (see FIG. 3).

FIG. 2b shows another longitudinal cross section of the closure device and securing device according to the invention. Supplementally to FIG. 2a, the headless screw serving as securing means 130 in the transverse bore 119 can be seen in particular. The headless screw 130 does not act directly on the cable section 210 to be locked in place but rather indirectly by way of a small metal plate 140, preferably of brass. See the discussion in the general part of the description above for the advantages of the small brass plate. By means of a threaded bore 136 extending transversely to the transverse bore 119, an additional securing means 135 in the form of a setscrew is tightened against the headless screw 130 to prevent undesired loosening.

FIG. 2c shows the closure device and the securing device according to the invention, where an inner sleeve 150 is provided, which is supported rotatably in the clamping sleeve 120 at the end facing the sling. Reference is made to the explanations given in the general part of the description above with respect to the function and the advantages of the inner sleeve. A slot with an insertion opening 121 for the insertion of at least one of the sling-forming cable sections with end-stop sleeve can be seen in the clamping sleeve.

FIG. 2d shows a longitudinal cross section of the closure device and securing device with inner sleeve 150 according to the invention.

FIGS. 2e and 2f show the inner sleeve 150 with a slot 152 for insertion of the cable sections of the sling and with notches 154 for engagement of the cable sections, as a result of which the inner sleeve 150 is prevented from rotating along with the clamping sleeve when the clamping sleeve is turned to clamp the cable sling.

As an alternative to the small metal plate 140, the headless screws 130 comprise a half-shell 132 at their end surfaces, as shown in FIG. 3, in order to distribute the pressure applied to the cable section over a large contact area and thus to prevent damage to the cable section by the headless screws.

The locking sleeve 110 comprises an outside thread 116, whereas the clamping sleeve 120 comprises a complementary inside thread 128. For this reason, the locking sleeve and the clamping sleeve can be screwed together, and the distance d between them can be variably adjusted. So that the clamping sleeve 120 can be screwed onto the locking sleeve 110, the clamping sleeve comprises, on its outside circumference, a hexagonal section 124, as shown by way of example in FIGS. 2a and 4, so that an open-end wrench, for example, can be placed on it to serve as a leveraging tool.

FIG. 4 shows the securing device according to the invention in a state in which the locking sleeve 110 and the clamping sleeve 120 are disconnected from each other. Sleeve securing means 122 in the form of headless screws on the outer circumference of the clamping sleeve 120 are to be seen in particular. These sleeve securing means serve to lock the clamping sleeve in a permanent relative position, that is, at a permanent distance d from the locking sleeve, after the clamping sleeve 120 has been screwed onto the locking sleeve 110. Alternatively or in addition to the headless screws, it's possible to use one or more small round milled-out areas extending at a slant in the front end of the clamping sleeve to serve as “latching points” for the wire cable. To prevent the connection from coming loose by itself, the locking sleeve and the clamping sleeve can be configured either alternatively or as an addition with a fine thread (pitch of 1 mm or less). Other types of threaded securing means, anaerobic adhesives, pins, or especially headless screws on the outer area of the upper hexagonal section are also conceivable, as is a configuration with elastic stop nuts. The clamping sleeve is preferably manufactured out of a material (e.g., brass) which is softer than that of the wire cable to avoid damage to the cable.

FIG. 5 shows the high-pressure device 400 according to the invention, which consists of the line 410, preferably a high-pressure line 410, a high-pressure fitting, and the securing device according to the invention.

The method according to the invention for mounting the securing device on a line is described in greater detail below with reference in particular to FIG. 5.

The first and second cable sections 210 and 220 in the form of a cable sling 200 of a provided cable are placed around a line 410 to be secured. The two cable sections 210 and 220 are then fed through the locking sleeve 110 and the clamping sleeve 120 in such a way that the clamping sleeve is arranged between the cable sling and the locking sleeve.

In the following method step, the clamping sleeve is first positioned as closely as possible to the locking sleeve or connected to it, so that the distance d is as short as possible. Because the length of the outside thread 116 is limited, the shorter the distance d in this step of the method, the longer the distance available later for reclamping. The cable sling 200 around the line 410 is first pulled tight by hand by pulling on the cable section 210, for example. Then the two cable sections 210, 220 are fixed immovably in the locking sleeve 110 by means of, for example, headless screws or by means of the previously mentioned end-stop sleeve.

To ensure that the cable sling is in fact locked immovably on the line 410, so that, in the case of an incident, it will not come loose from the line 410, the cable sling is reclamped. For this purpose, the distance between the distance d between the locking sleeve 110 and the clamping sleeve 120 is increased by unscrewing the two sleeves to an appropriate extent.

It is recommended to the user that the forward area of the outside thread 116 be of a contrasting color so that it can function as a warning area, i.e., the area beyond which the clamping sleeve should not be unscrewed during the clamping process. If this point is reached during the clamping process but the desired degree of tightness has not yet been achieved (e.g., because the wire cable has stretched, or the like), the possibility of “reclamping” is available, which means that the mounting steps starting from the first manual fixation of the sling by means of the headless screw are repeated.

It is also conceivable that the fed-through wire cable could carry this color-coded marking, which would be visible through the insertion slot 112.

To prevent the cable sections 210, 220 from being damaged by a burr on the sling-facing opening of the bore in the clamping sleeve 120, this sling-facing opening of the bore comprises preferably a straight-walled or conical countersink 126. It is also advantageous for the opening of the bore in the locking sleeve 110 facing away from the sling to comprise a countersink 115 in order to avoid damage to the cable section emerging from the locking sleeve, i.e., damage which could occur at times when this cable section, in the event of an incident, is subjected to forces acting transversely to the longitudinal direction of the bore in the locking sleeve.

Before or after the reclamping of the cable sling, the free end 225 of the cable is preferably fastened to a stationary object such as the high-pressure fitting 420 of the high-pressure device 400, preferably by means of a connecting means 300 in the form of, for example, an eyelet.

If an incident occurs, that is, if the line 410 should come loose from the high-pressure fitting 420 under pressure in the operating state, the securing device according to the invention ensures that the loose end of the high-pressure line will not cause too much damage, because it can travel away from the high-pressure device 400 only as far as the cable or capture cable allows. By means of the closure device according to the invention, it is ensured that the cable or capture cable can be fixed immovably on the line 410 by simple, uncomplicated mounting procedure and cannot come loose from the line even under tensile load. This is also guaranteed, especially in the case of elastomeric lines, by the fact that the edge of the bore in the clamping sleeve facing the sling will dig itself into the surface of the line when tensile loads occur in a direction transverse to the longitudinal axis of the bore. It is also important to point out, however, that the actual safety of the system, when subjected to load, is achieved exclusively by the sling effect, which would become even stronger under load, even if the clamping sleeve were not properly secured on the locking sleeve. The “sling effect” means that the sling is automatically pulled even tighter when subjected to load, as long as a first partial section of the cable is fixed immovably in the locking sleeve by means of, for example, the end-stop sleeve and the second section of the cable is not immovably fixed. The clamping sleeve and the headless screws are required to withstand only the forces required to prevent the cable from slipping during the clamping step; these forces are comparatively small.

A rubber sheath around the secured line to protect its surface is also conceivable and would have little or no negative effect on the strength of the connection.

The overall structure also offers the advantage that the end-stop sleeve 230, in the case of an incident, is not required to absorb all of the tensile force under a load capable of breaking the line; instead, the structure at this point is held primarily by the “friction” of the tightly-pulled cable around the circumference of the line. This gives the overall structure a high degree of overall strength. A safety under load is achieved which corresponds to the breaking load of the wire cable.

FIG. 6 shows, first, a plastic tube 500, which is pushed over the cable sling 200, for example, to protect it. Second, in the case of the exemplary embodiment shown in

FIG. 6, the free end 225 of the cable is formed into a second cable sling and guided back into the locking sleeve 110 and fixed there as a third cable section in its own separate bore or in a common bore shared with the first and second, cable sections.

### LIST OF REFERENCE SYMBOLS

100 closure device
110 locking sleeve
112 slot
114 bore for a cable section
115 countersink
116 outside thread
117 bore for a cable section
119 transverse bore
120 clamping sleeve
122 sleeve securing means, e.g., headless screw
124 hexagon
126 countersink
128 inside thread
130 cable-securing means, e.g., headless screw
132 half-shells
135 additional securing means, e.g., additional setscrew
136 bore for additional securing means
140 small metal plate
150 inner sleeve
152 slot in the inner sleeve
154 notch
200 cable sling
210 cable section
220 cable section
225 free end
230 end-stop sleeve
240 turning point of the cable sling
300 connecting means
400 high-pressure device
410 high-pressure hose, line
420 high-pressure fitting
500 plastic hose
d distance

1-22. (canceled)

23. A closure device for at least one sling of a cable, wherein the cable sling is formed out of a first cable section and a second cable section, wherein the closure device comprises:
a locking sleeve, through which the first and second cable sections can be fed; and
a clamping sleeve, through which the first and second cable sections can be fed,
wherein the locking sleeve is formed with an outside thread and the clamping sleeve with a complimentary inside thread, or vice versa, so that the two sleeves can be screwed together, wherein the locking sleeve and the clamping sleeve, holding the cable sections which have been fed through both sleeves, are fixable in variably adjustable relative positions to each other for reclamping the cable sling around a line by partially unscrewing a screw connection between the locking sleeve and the clamping sleeve to a greater distance; and
cable securing means are provided for locking the first and second cable sections in the locking sleeve so that the cable sling will not loosen.

24. The closure device according to claim 23, wherein the locking sleeve and/or the clamping sleeve comprises its own separate bores for the first and second cable sections.

25. The closure device according to claim 23, wherein the locking sleeve and/or the clamping sleeve comprises a common bore for the first and second cable sections.

26. The closure device according to claim 24, wherein the locking sleeve and/or the clamping sleeve comprises at least one slot extending in a longitudinal direction of the bore, which at least one slot communicates with the bore for insertion of the cable section into the bore in the sleeve.

27. The closure device according to claim 24, wherein the cable securing means includes at least one headless screw, which can be screwed radially, i.e., transversely to the longitudinal axis of the bore, into the bore in the locking sleeve to permanently clamp the cable sections in the bore.

28. The closure device according to claim 27, further comprising a small plate of a metal softer than steel laid between an end surface of the headless screw and the cable section to be permanently clamped.

29. The closure device according to claim 24, wherein the bore of the locking sleeve has a widened area at an end facing away from the sling to accommodate an end-stop sleeve on one end of the cable.

30. The closure device according to claim 27, further comprising sleeve securing means, in the form of headless screws, for securing the locking sleeve and the clamping sleeve in certain relative positions to each other.

31. The closure device according to claim 30, further comprising additional securing means for securing the cable-securing means and/or the sleeve-securing means.

32. The closure device according to claim 24, further comprising an inner sleeve for insertion into a sling-facing end of the clamping sleeve and for passage of the first and second cable sections.

33. The closure device according to claim 32, wherein, at an end facing the sling, the bore in the clamping sleeve or a bore in the inner sleeve and/or, at an end facing away from the sling, the bore in the locking sleeve comprises a countersink.

34. The closure device according to claim 23, wherein a hexagonal section, a set of two opposing flats with holes for hooks, and/or a knurled edge is formed on a circumference of the locking sleeve and/or of the clamping sleeve.

35. A securing device for a line comprising:
a cable having a sling formed out of a first cable section and a second cable section; and
a closure device for at least one sling of the cable, which can be placed around the line, wherein the closure device comprises a locking sleeve through which the first and second cable sections can be fed, and a clamping sleeve through which the first and second cable sections can be fed, wherein the locking sleeve is formed with an outside thread and the clamping sleeve with a complimentary inside thread, or vice versa, so that the two sleeves can be screwed together, wherein the locking sleeve and the clamping sleeve, holding the cable sections which have been fed through both sleeves, are fixable in variably adjustable relative positions to each other for reclamping the cable sling around a line by partially unscrewing a screw connection between the locking sleeve and the clamping sleeve to a greater distance, and cable securing means are provided for locking the first and second cable sections in the locking sleeve so that the cable sling will not loosen.

36. The securing device according to claim 23, comprising a connecting means for connecting a free end of the cable, the free end facing away from the sling, to a stationary object.

37. The securing device according to claim 35, wherein the cable is a wire cable.

38. The securing device according to claim 35, wherein the cable comprises an end-stop sleeve at one end; and the locking sleeve has a bore with a widened area at an end facing away from the sling to accommodate the end-stop sleeve.

39. The securing device according to claim 35, further comprising plastic tubing that surrounds the cable sling.

40. A high-pressure device comprising:
a line;
a high-pressure fitting to which the line is connected;
at least one securing device including a cable having a sling formed out of a first cable section and a second cable section; and
a closure device for at least one sling of the cable, which can be placed around the line, wherein the closure device comprises a locking sleeve through which the first and second cable sections can be fed, and a clamping sleeve through which the first and second cable sections can be fed, wherein the locking sleeve is formed with an outside thread and the clamping sleeve with a complimentary inside thread, or vice versa, so that the two sleeves can be screwed together, wherein the locking sleeve and the clamping sleeve, holding the cable sections which have been fed through both sleeves, are fixable in variably adjustable relative positions to each other for reclamping the cable sling around a line by partially unscrewing a screw connection between the locking sleeve and the clamping sleeve to a greater distance, and cable securing means are provided for locking the first and second cable sections in the locking sleeve so that the cable sling will not loosen, wherein the sling of the cable is placed around the line and immovably locked in position on the line by the closure device; and wherein a free end of the cable is connected to the high-pressure fitting or to some other stationary object by a connecting device or by an additional securing device.

41. A high-pressure device according to claim 40, wherein the connecting device is configured as an eyelet or clamp that engages with the high-pressure fitting or the other stationary object.

42. A method for mounting the securing device according to claim 35 on a line, comprising the steps of:
providing a cable;
placing the cable, the first and second sections of which are in the form of a sling, around the line;
feeding the two cable sections through a locking sleeve and a clamping sleeve in such a way that the clamping sleeve is arranged between the cable sling and the locking sleeve;
positioning the clamping sleeve at a shortest possible distance from the locking sleeve;
pulling the sling tight around the line;
locking the two cable sections in the locking sleeve while the sling is tightened around the line at least so that the sling cannot be loosened; and
reclamping the cable sling around the line by partially unscrewing the screw connection between the locking sleeve and the clamping sleeve to a greater distance.

43. The method according to claim 42, wherein, when the second cable section comprises an end-stop sleeve, the step of feeding the cable section through the locking sleeve comprising the following steps:
feeding an end of the cable facing away from the end stop sleeve through the bore in the locking sleeve and Dulling the end-stop sleeve into a widened area in the bore into which the end-stop sleeve fits.

44. The method according to claim 42, wherein, after the reclamping step, the method further comprises the following method step:
connecting a free end of the cable facing away from the sling around the line to a stationary object.
